(19) United States
(12) Patent Application Publication
(10) Pub. No.: US 2014/0072223 A1
(43) Pub. Date: Mar. 13, 2014

(54) Embedding Media Content Within Image Files And Presenting Embedded Media In Conjunction With An Associated Image

(71) Applicant: KOEPICS, SL, Barcelona (ES)

(72) Inventor: Marc Sallent Aspa, Barcelona (ES)

(73) Assignee: KOEPICS, SL, Barcelona (ES)

(21) Appl. No.: 14/026,323

(22) Filed: Sep. 13, 2013

Related U.S. Application Data
(60) Provisional application No. 61/700,589, filed on Sep. 13, 2012.
(60) Provisional application No. 61/786,936, filed on Mar. 15, 2013.

(51) Int. Cl. G06K 9/46

(52) U.S. Cl. CPC G06K 9/46
USPC 382/181; 382/276

(57) ABSTRACT

Systems and methods are disclosed for embedding media content and providing media content. In one implementation, media content can be received and the media content can be codified as encoded data based on one or more encoding formats. The encoded data can be embedded within an image file and a composite of the image file and the media content can be provided. In another implementation, an image identifier can be identified within a content page. The image identifier can correspond to a digital image file which can include image data and supplemental data. The image identifier can be processed to identify a source address of the digital image file. Based on the source address, source code information of the digital image file can be requested. The source code information can be processed to identify the supplemental data and the supplemental data can be provided in conjunction with the content page.

### CROSS-REFERENCE TO RELATED APPLICATIONS

This application is related to and claims the benefit of U.S. patent application Ser. No. 61/700,589, filed Sep. 13, 2012 and U.S. patent application Ser. No. 61/786,936, filed Mar. 15, 2013, the entirety of which are incorporated herein by reference.

### BACKGROUND

While digital imaging has become commonplace in many settings and scenarios, common file formats that are used in such settings (e.g., .JPEG) are generally only utilized for the storage of such images.

### SUMMARY

Technologies are presented herein in support of systems and methods for embedding media content and/or presenting embedded media content. According to one aspect, media content can be received and the media content can be codified as encoded data based on one or more encoding formats. The encoded data can be embedded within an image file and a composite of the image file and the media content can be provided.

According to another aspect, an image identifier can be identified within a content page. Such an image identifier can correspond to a digital image file which can include image data and supplemental data. The image identifier can be processed to identify a source address of the digital image file. Based on the source address, source code information of the digital image file can be requested. The source code information can be processed to identify the supplemental data and the supplemental data can be provided in conjunction with the content page.

These and other aspects, features, and advantages can be appreciated from the accompanying description of certain embodiments and the accompanying drawing figures and claims.

### BRIEF DESCRIPTION OF THE DRAWINGS

FIG. 1 is a high-level diagram illustrating an exemplary configuration of an image enhancement system, in accordance with at least one implementation of the present disclosure.

FIG. 2 is a high-level diagram illustrating an exemplary configuration of a content presentation system, in accordance with at least one implementation of the present disclosure.

FIG. 3 is a flow diagram showing a routine that illustrates a broad aspect of a method for embedding media content within an image file in accordance with at least one embodiment disclosed herein.

FIG. 4 is a flow diagram showing a routine that illustrates a broad aspect of a method for providing content in accordance with at least one embodiment disclosed herein.

FIG. 5 depicts source code of a web page that includes one or more image identifiers, in accordance with at least one embodiment disclosed herein.

FIG. 6 depicts an exemplary structure of an image file having image data and supplemental data, in accordance with at least one embodiment disclosed herein.

FIG. 7 depicts an example of such a script in accordance with at least one embodiment disclosed herein.

FIG. 8 depicts examples of various source paths corresponding to various image files, in accordance with at least one embodiment disclosed herein.

FIG. 9 depicts an exemplary scenario whereby a digital image file is requested, in accordance with at least one embodiment disclosed herein.

FIG. 10 depicts the source code information of an image file in accordance with at least one embodiment disclosed herein.

### DETAILED DESCRIPTION OF CERTAIN EMBODIMENTS

Described herein are systems and methods that enable the embedding of media information (e.g., audio content, video content, etc.) within a file such an image file (such as in an existing file format, e.g., .jpeg, .tiff, etc.), as well as systems and methods that enable such embedded content to be requested, extracted, and/or presented to a user (e.g., as an audio stream) together with the associated image data (e.g., the pixels that make up the image). As described herein, by embedding such multimedia content within an existing file format, such as an image file, the image file can remain usable/viewable, retaining the ability to display the original, uncorrupted image on programs or devices that are otherwise capable of viewing such an image file, even those that are not otherwise enabled to read the embedded multimedia information (that is, it can be said that the image file is ‘backwards compatible’). As also described herein, multimedia content/information can be embedded within an image file in a way that image libraries not otherwise enabled to process/recognize the multimedia information will interpret the image correctly (in certain scenarios, such content may launch alerts or errors). Moreover, enabled programs or devices (that is, applications/devices that are capable of identifying the embedded multimedia content in addition to the image file, including but not limited to those described and/or referenced herein) can play and/or otherwise utilize the embedded information and also view the original image. It should be noted that in certain implementations that image file and the embedded content can be generated and subsequently displayed/viewed in a coordinated presentation, as described herein. In doing so, in addition to requesting and presenting the image content of an image file (e.g., information pertaining to the pixels of an image), the embedded content (e.g., an audio file) can also be identified and presented in conjunction with the image data (e.g., within the same web page).

The following detailed description is directed to systems and methods for embedding content (such as media content) and presenting such content (e.g., within a webpage and/or an application). The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

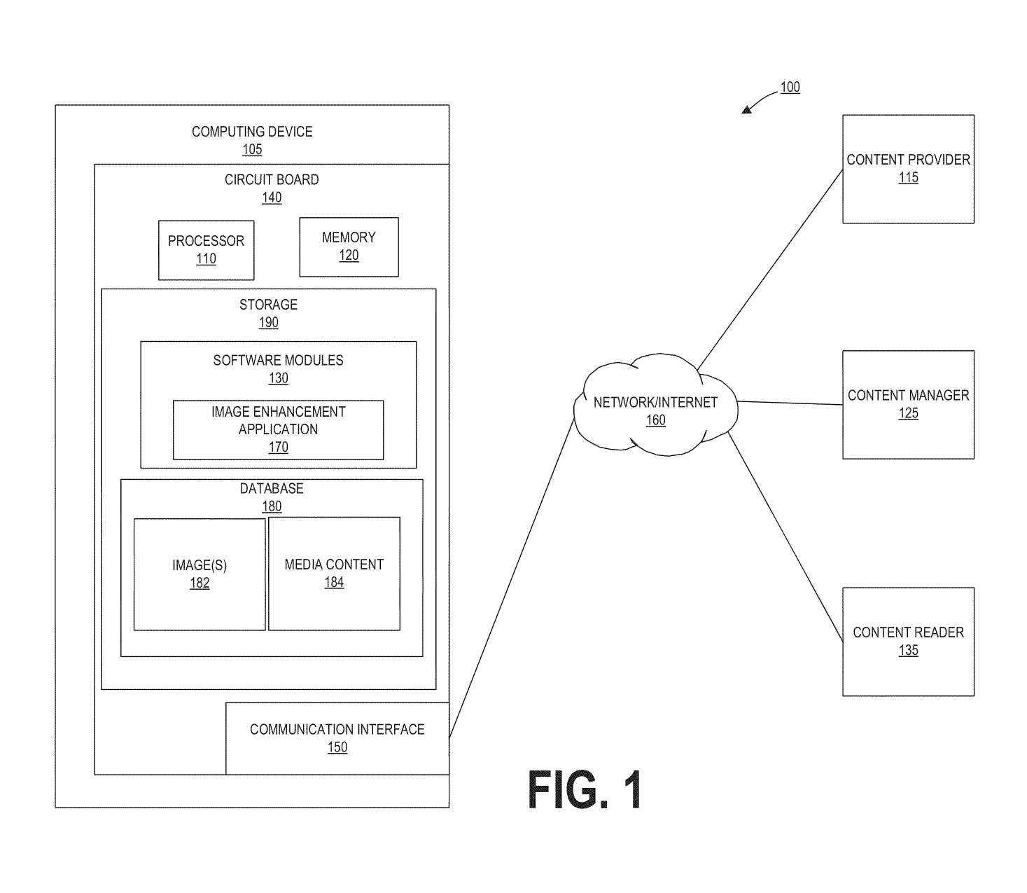

An exemplary computer system is shown as a block diagram in FIG. 1 which is a high-level diagram illustrating an exemplary configuration of an image enhancement system 100. In one implementation, computing device 105 can be a personal computer or server. In other implementations, computing device 105 can be a tablet computer, a laptop computer, or a mobile device/smartphone, though it should be understood that computing device 105 of image enhancement system 100 can be practically any computing device and/or data processing apparatus capable of embodying the systems and/or methods described herein.

Computing device 105 of image enhancement system 100 includes a circuit board 140, such as a motherboard, which is operatively connected to various hardware and software components that serve to enable operation of the image enhancement system 100. The circuit board 140 is operatively connected to a processor 110 and a memory 120. Processor 110 serves to execute instructions for software that can be loaded into memory 120. Processor 110 can be a number of processors, a multi-processor core, or some other type of processor, depending on the particular implementation. Further, processor 110 can be implemented using a number of heterogeneous processor systems in which a main processor is present with secondary processors on a single chip. As another illustrative example, processor 110 can be a symmetric multi-processor system containing multiple processors of the same type.

Preferably, memory 120 and/or storage 190 are accessible by processor 110, thereby enabling processor 110 to receive and execute instructions stored on memory 120 and/or on storage 190. Memory 120 can be, for example, a random access memory (RAM) or any other suitable volatile or non-volatile computer readable storage medium. In addition, memory 120 can be fixed or removable. Storage 190 can take various forms, depending on the particular implementation. For example, storage 190 can contain one or more components or devices such as a hard drive, a flash memory, a rewritable optical disk, a rewritable magnetic tape, or some combination of the above. Storage 190 also can be fixed or removable.

One or more software modules 130 are encoded in storage 190 and/or in memory 120. The software modules 130 can comprise one or more software programs or applications having computer program code or a set of instructions executed in processor 110. Such computer program code or instructions for carrying out operations for aspects of the systems and methods disclosed herein can be written in any combination of one or more programming languages, including an object oriented programming language such as Java, Smalltalk, C++, Python, and JavaScript or the like and conventional procedural programming languages, such as the “C” programming language or similar programming languages. The program code can execute entirely on computing device 105, partly on computing device 105, as a stand-alone software package, partly on computing device 105 and partly on a remote computer/device, or entirely on the remote computer/device or server. In the latter scenario, the remote computer can be connected to computing device 105 through any type of network, including a local area network (LAN) or a wide area network (WAN), or the connection can be made to an external computer (for example, through the Internet 160 using an Internet Service Provider).

One or more software modules 130, including program code/instructions, are located in a functional form on one or more computer readable storage devices (such as memory 120 and/or storage 190) that can be selectively removable. The software modules 130 can be loaded onto or transferred to computing device 105 for execution by processor 110. It can also be said that the program code of software modules 130 and one or more computer readable storage devices (such as memory 120 and/or storage 190) form a computer program product that can be manufactured and/or distributed in accordance with the present disclosure, as is known to those of ordinary skill in the art.

It should be understood that in some illustrative embodiments, one or more of software modules 130 can be downloaded over a network to storage 190 from another device or system via communication interface 150 for use within image enhancement system 100. For instance, program code stored in a computer readable storage device in a server can be downloaded over a network from the server to image enhancement system 100.

In certain implementations, included among the software modules 130 is an image enhancement application 170 that is executed by processor 110. During execution of the software modules 130, and specifically the image enhancement application 170, the processor 110 configures the circuit board 140 to perform various operations relating to image enhancement with computing device 105, as will be described in greater detail below. It should be understood that while software modules 130 and/or image enhancement application 170 can be embodied in any number of computer executable formats, in certain implementations software modules 130 and/or image enhancement application 170 comprise one or more applications that are configured to be executed at computing device 105 in conjunction with one or more applications or ‘apps’ executing at remote devices, such as computing device(s) 115, 125, and/or 135 and/or one or more viewers such as internet browsers and/or proprietary applications. Furthermore, in certain implementations, software modules 130 and/or image enhancement application 170 can be configured to execute at the request or selection of a user of one of computing devices 115, 125, and/or 135 (or any other such user having the ability to execute a program in relation to computing device 105, such as a network administrator), while in other implementations computing device 105 can be configured to automatically execute software modules 130 and/or image enhancement application 170, without requiring an affirmative request to execute. It should also be noted that while FIG. 1 depicts memory 120 oriented on circuit board 140, in an alternate arrangement, memory 120 can be operatively connected to the circuit board 140. In addition, it should be noted that other information and/or data relevant to the operation of the present systems and methods (such as database 180) can also be stored on storage 190, as will be discussed in greater detail below.

Also preferably stored on storage 190 is database 180. As will be described in greater detail below, database 180 contains and/or maintains various data items and elements that are utilized throughout the various operations of image enhancement system 100, including but not limited to images 182 and media content 184, as described herein. It should be noted that although database 180 is depicted as being configured locally to computing device 105, in certain implementations database 180 and/or various of the data elements stored therein can be located remotely (such as on a remote device or server—not shown) and connected to computing device 105 through network 160, in a manner known to those of ordinary skill in the art.

As referenced above, it should be noted that in certain implementations, such as the one depicted in FIG. 1, one or more of the computing devices 115, 125, 135 can be in periodic or ongoing communication with computing device 105 thorough a computer network such as the Internet 160. Though not shown, it should be understood that in certain other implementations, computing devices 115, 125, and/or 135 can be in periodic or ongoing direct communication with computing device 105, such as through communications interface 150.

Communication interface 150 is also operatively connected to circuit board 140. Communication interface 150 can be any interface that enables communication between the computing device 105 and external devices, machines and/or elements. Preferably, communication interface 150 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting computing device 105 to other computing devices and/or communication networks such as private networks and the Internet. Such connections can include a wired connection or a wireless connection (e.g. using the 802.11 standard) though it should be understood that communication interface 150 can be practically any interface that enables communication to/from the circuit board 140.

At various points during the operation of image enhancement system 100, computing device 105 can communicate with one or more computing devices, such as those controlled and/or maintained by one or more individuals and/or entities, such as content provider 115, content manager 125, and/or content reader 135, each of which will be described in greater detail herein. Such computing devices transmit and/or receive data to/from computing device 105, thereby preferably initiating maintaining, and/or enhancing the operation of the image enhancement system 100, as will be described in greater detail below. It should be understood that the computing devices 115 can be in direct communication with computing device 105, indirect communication with computing device 105, and/or can be communicatively coordinated with computing device 105, as will be described in greater detail below. While such computing devices can be practically any device capable of communication with computing device 105, in the preferred embodiment certain computing devices are preferably servers, while other computing devices are preferably user devices (e.g., personal computers, handheld/portable computers, smartphones, etc.), though it should be understood that practically any computing device that is capable of transmitting and/or receiving data to/from computing device 105 could be similarly substituted.

It should be noted that while FIG. 1 depicts image enhancement system 100 with respect to computing devices 115, 125, and 135, it should be understood that any number of computing devices can interact with the image enhancement system 100 in the manner described herein. It should be further understood that a substantial number of the operations described herein are initiated by and/or performed in relation to such computing devices. For example, as referenced above, such computing devices can execute applications and/or viewers which request and/or receive data from computing device 105, substantially in the manner described in detail herein.

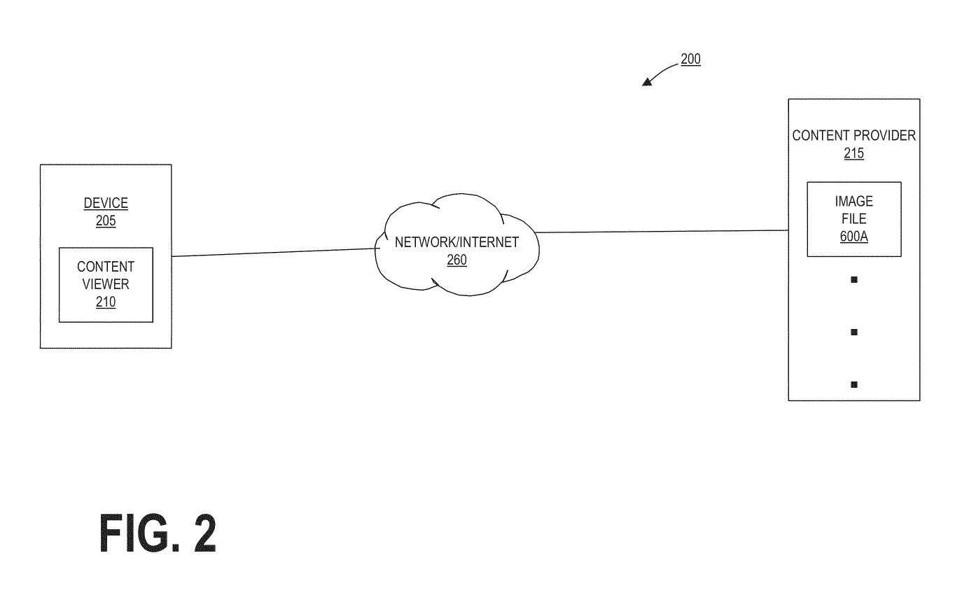

FIG. 2 depicts another implementation of the technologies described herein. As shown in FIG. 2, a content presentation system 200 is provided, which can include a device 205 (e.g., a user device such as a computer, mobile device, smartphone, etc.) having a content viewer 210 such as a web browser or any other such application capable of requesting, receiving and/or presenting content to a user. At various points in time, device 205 can be in communication with content provider 215 via network/internet 260, such as in a manner known to those of ordinary skill in the art. Content provider 215 can be a computing device such as a computer, server, webserver, etc., and can include one or more image files in a storage device such as image file 600A. As described in detail herein, such image files can include both image data (e.g., data pertaining to the visual aspects of an image such as pixel data) as well as supplemental data (e.g., metadata such as a header, footer, EXIF tag, etc.). Moreover, as described herein, media content such as audio content (or any other such content) can be embedded within such supplemental data, such as in a manner described herein. It should be noted that the various elements depicted in FIG. 2 are done so for the sake of clarity and/or simplicity. However it should be understood that, though not explicitly described/depicted, any number of additional components and/or elements can be similarly included within any of the depicted elements, included but not limited to elements depicted and/or described in connection with FIG. 1.

In the description that follows, certain embodiments and/or arrangements are described with reference to acts and symbolic representations of operations that are performed by one or more devices, such as the image enhancement system 100 of FIG. 1 and/or the content presentation system 200 of FIG. 2. As such, it will be understood that such acts and operations, which are at times referred to as being computer-executed or computer-implemented, include the manipulation by processor 110 of electrical signals representing data in a structured form. This manipulation transforms the data and/or maintains them at locations in the memory system of the computer (such as memory 120 and/or storage 190), which reconfigures and/or otherwise alters the operation of the system in a manner understood by those skilled in the art. The data structures in which data are maintained are physical locations of the memory that have particular properties defined by the format of the data. However, while an embodiment is being described in the foregoing context, it is not meant to provide architectural limitations to the manner in which different embodiments can be implemented. The different illustrative embodiments can be implemented in a system including components in addition to or in place of those illustrated for the image enhancement system 100 and/or the content presentation system 200 of FIG. 2. Other components shown in FIG. 1 and/or FIG. 2 can be varied from the illustrative examples shown. The different embodiments can be implemented using any hardware device or system capable of running program code. In another illustrative example, image enhancement system 100 and/or the content presentation system 200 of FIG. 2 can take the form of a hardware unit that has circuits that are manufactured or configured for a particular use. This type of hardware can perform operations without needing program code to be loaded into a memory from a computer readable storage device to be configured to perform the operations.

For example, computing device 105 can take the form of a circuit system, an application specific integrated circuit (ASIC), a programmable logic device, or some other suitable type of hardware configured to perform a number of operations. With a programmable logic device, the device is configured to perform the number of operations. The device can be reconfigured at a later time or can be permanently configured to perform the number of operations. Examples of programmable logic devices include, for example, a programmable logic array, programmable array logic, a field programmable logic array, a field programmable gate array, and other suitable hardware devices. With this type of implementation, software modules 130 can be omitted because the processes for the different embodiments are implemented in a hardware unit.

In still another illustrative example, computing device 105 can be implemented using a combination of processors found in computers and hardware units. Processor 110 can have a number of hardware units and a number of processors that are configured to execute software modules 130. In this example, some of the processors can be implemented in the number of hardware units, while other processors can be implemented in the number of processors.

In another example, a bus system can be implemented and can be comprised of one or more buses, such as a system bus or an input/output bus. Of course, the bus system can be implemented using any suitable type of architecture that provides for a transfer of data between different components or devices attached to the bus system. Additionally, communications interface 150 can include one or more devices used to transmit and receive data, such as a modem or a network adapter.

Embodiments and/or arrangements can be described in a general context of computer-executable instructions, such as program modules, being executed by a computer. Generally, program modules include routines, programs, objects, components, data structures, etc., that perform particular tasks or implement particular abstract data types.

It should be further understood that while the various computing devices and machines referenced herein, including but not limited to computing devices 105, 205, 115, 125, 135, and 215 are referred to herein as individual/single devices and/or machines, in certain implementations the referenced devices and machines, and their associated and/or accompanying operations, features, and/or functionalities can be arranged or otherwise employed across any number of devices and/or machines, such as over a network connection, as is known to those of skill in the art.

It should also be noted that, although not shown in FIGS. 1 and 2, various additional components can be incorporated within and/or employed in conjunction with the various computing device(s). For example, computing device 105 can include an embedded and/or peripheral image capture device such as a camera and/or an embedded and/or peripheral audio capture device such as a microphone.

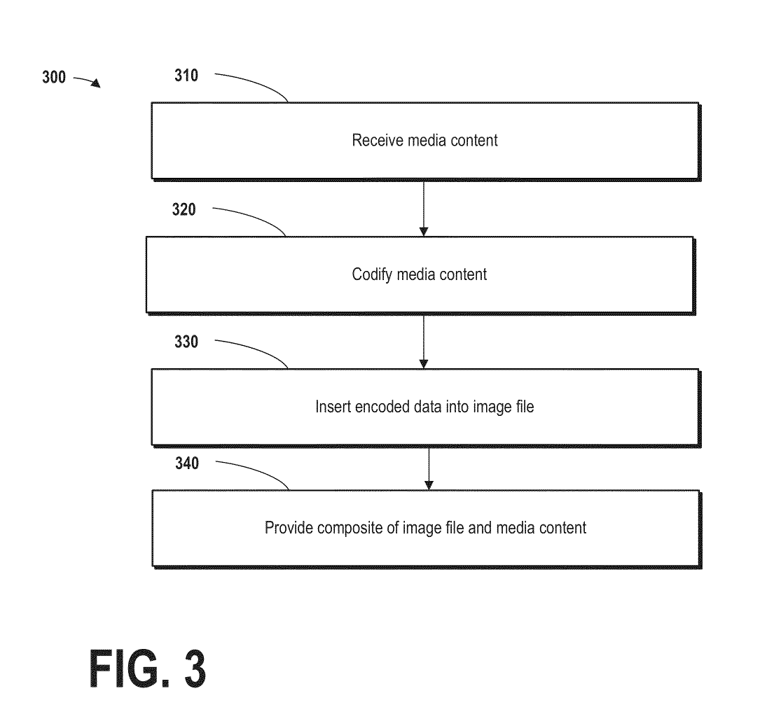

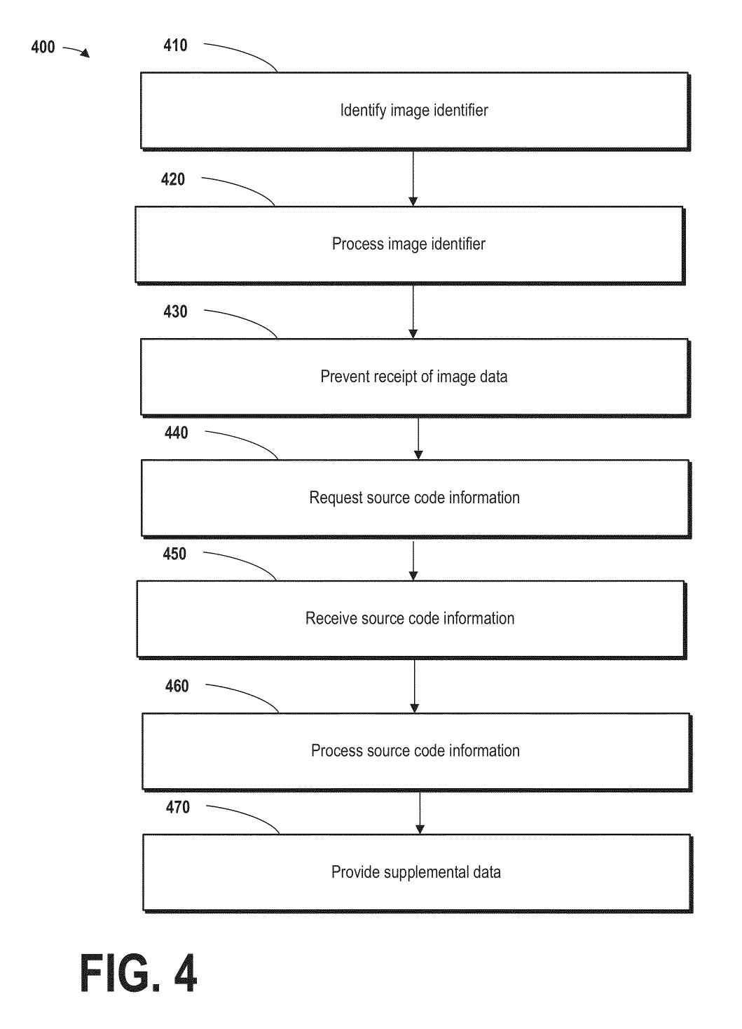

The operation of the image enhancement system 100 and/or the content presentation system 200 of FIG. 2 and the various elements and components described above will be further appreciated with reference to the various methods described herein, such as in conjunction with FIGS. 3-4.

Turning now to FIG. 3, a flow diagram is described showing a routine 300 that illustrates a broad aspect of a method for embedding multimedia content in accordance with at least one embodiment disclosed herein. It should be appreciated that several of the logical operations described herein are implemented (1) as a sequence of computer implemented acts or program modules running on image enhancement system 100 and/or the content presentation system 200 of FIG. 2 and/or (2) as interconnected machine logic circuits or circuit modules within the image enhancement system 100 and/or the content presentation system 200. The implementation is a matter of choice dependent on the requirements of the device (e.g., size, energy, consumption, performance, etc.). Accordingly, the logical operations described herein are referred to variously as operations, steps, structural devices, acts, or modules. As referenced above, one or more of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

At 310, processor 110 executing one or more of software modules 130, including, in certain implementations, image enhancement application 170, configures computing device 105 to receive content such as multimedia content, including but not limited to audio files/data (e.g., .MP3 files, .WAV files, etc.) and/or any other media content (e.g., videos such as .MPEG files), as are known to those of ordinary skill in the art. For example, such media content can be captured concurrent with the capture of an image file (e.g., an audio clip can be recorded in conjunction with the capture of an image by a camera). By way of further example, such media content can be previously stored and/or created independent of the capture/generation of an image file.

Then, at 320, processor 110 executing one or more of software modules 130, including, in certain implementations, image enhancement application 170, configures computing device 105 to codify the media content (such as the content received at 310). In certain implementations, such media content can be codified as encoded data, such as based on one or more encoding formats. In doing so, the binary data of the media content, such as an audio file (which can be in practically any format and/or codification), can be generated/identified. Having identified the binary data of the media content (e.g., the audio file), such data can be re-codified, such as into Base64, Base32, and/or any other such encoding). For example, an audio file can be codified using an encoding that utilizes ASCII characters, Unicode or JIS, and/or any other such encoding supported by exchangeable image file format (EXIF) tags, such as in a manner known to those of ordinary skill in the art.

At 330, processor 110 executing one or more of software modules 130, including, in certain implementations, image enhancement application 170, configures computing device 105 to insert the encoded data (such as the data encoded at 320) into an image file. For example, in certain implementations the encoded data (e.g., the media content codified at 320) can be added to or otherwise incorporated/embedded within an EXIF tag of the image, such as in a manner known to those of ordinary skill in the art. In such an implementation, in scenarios where the media content (e.g., an audio file) is larger/longer than the size appropriate for the EXIF tag (e.g., in the case of a high quality and/or long audio file), the EXIF can be allowed to overflow, such as in a manner known to those of ordinary skill in the art.

Moreover, in certain implementations, the encoded data can be added to or otherwise incorporated/embedded within an EXIF tag of the image by adding a distinctive/identifiable string as a marker at the end of the EXIF tag. Such a string can function to identify the embedded media content (e.g., the audio data and/or the beginning and/or end thereof). In a scenario where the media content (e.g., the audio file) is larger/longer than the appropriate size for the EXIF tag, the EXIF tag can be allowed to overflow, such as in a manner known to those of ordinary skill in the art.

Additionally, in certain implementations, the encoded data can be added to or otherwise incorporated/embedded within the image in an EXIF tag by splitting the media content (e.g., the audio file) into pieces/elements (whether of equal or unequal size), each of which can be added to one or several EXIF tags.

It should also be noted that, in certain implementations, the media content (e.g., audio information) can also and/or alternatively be added in other JPEG markers (e.g., from APP0 to APP14) or any other such other markers that are introduced, substantially in the same manner described above.

At this juncture, it should be understood that, in certain implementations, a determination can also be made regarding the manner in which the encoded data (corresponding to the media content, e.g., an audio file) is inserted/incorporated into the image file. In certain implementations, such a determination can be made based on any number of factors. For example, the referenced determination can be made based on one or more aspects or characteristics pertaining to the encoded data, such as how permissive the library used as the JPEG encoder or decoder is (as some libraries will return warnings when detecting overflows or simply ignore such warnings and will continue working, while other libraries do not tolerate overflows and will produce an error in the process). By way of further example, the weight of the resulting image file size can also be used to determine the manner in which the encoded data is inserted into the image file.

At 340, processor 110 executing one or more of software modules 130, including, in certain implementations, image enhancement application 170, configures computing device 105 to provide a composite of the image file and the media content. That is, it should be appreciated that, having inserted, embedded, or otherwise incorporated the encoded data into the image file (such as at 330), the enhanced image file (that is, the image file having the media content embedded therein) can be provided and/or viewed in a manner that enables the viewer to access both the image as well as the encoded media content inserted therein. It should be appreciated that, in certain implementations, the manner in which the encoded media information (e.g., audio information) is subsequently played, viewed, or otherwise retrieved can correspond to a respective manner in which the multimedia information was encoded/inserted/embedded (such as is described at 330). By way of illustration, in one implementation a selected EXIF tag can be read, looking for audio information and, upon identifying it, such audio information can be decoded (such as from Base64, Base32 or any other such encoding) back into binary, thereby enabling the audio information (or any other such media content) to be played.

Moreover, in certain implementations, an EXIF tag can be read from its beginning until reaching the distinctive string included therein (in a scenario where such a distinctive string has been created, as referenced above). Upon identifying such a string, media content (e.g., audio information) can be decoded from that point on (such as from Base64, Base32 or any other such encoding) back into binary thereby enabling the audio information (or any other such media content) to be played, viewed, etc.

Additionally, in certain implementations, media information can be obtained from multiple EXIF tags, and such information can be combined/put together into a single string. Such a single string can then be decoded (such as from Base64, Base32 or any other such encoding) back into binary, thereby enabling the audio information (or any other such multimedia content) to be played, such as in a manner described herein. It should also be noted that, in certain implementations, the content of each respective EXIF tag can be decoded and then joined together into a single multimedia file.

In yet other implementations, multimedia information can be obtained from the information contained within any JPEG Markers (e.g., from APP0 to APP14) or any other such other markers that are introduced, by looking for encoded media (e.g., audio) information. Such information can be decoded (such as from Base64, Base32 or any other such encoding) back into binary thereby enabling the audio information (or any other such multimedia content) to be played.

In certain implementations, the image file and the media content that is embedded or otherwise incorporated therein can be captured in a coordinated fashion. For example, computing device 105 (e.g., a camera, as described herein) can capture the image file, and capture audio content immediately preceding, succeeding, and/or concurrently with the capture of the image file. Such audio content can then be embedded within the image file, such as in the various manners described herein. Such audio content (e.g., explanatory audio which describes the content of the image) can subsequently be identified and/or played, such as when a user views the captured image.

Turning now to FIG. 4, a flow diagram is described showing a routine 400 that illustrates a broad aspect of a method for presenting content in accordance with at least one embodiment disclosed herein. It should be appreciated that several of the logical operations described herein are implemented (1) as a sequence of computer implemented acts or program modules running on image enhancement system 100 and/or the content presentation system 200 and/or (2) as interconnected machine logic circuits or circuit modules within the image enhancement system 100 and/or the content presentation system 200. The implementation is a matter of choice dependent on the requirements of the device (e.g., size, energy, consumption, performance, etc.). Accordingly, the logical operations described herein are referred to variously as operations, steps, structural devices, acts, or modules. As referenced above, one or more of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

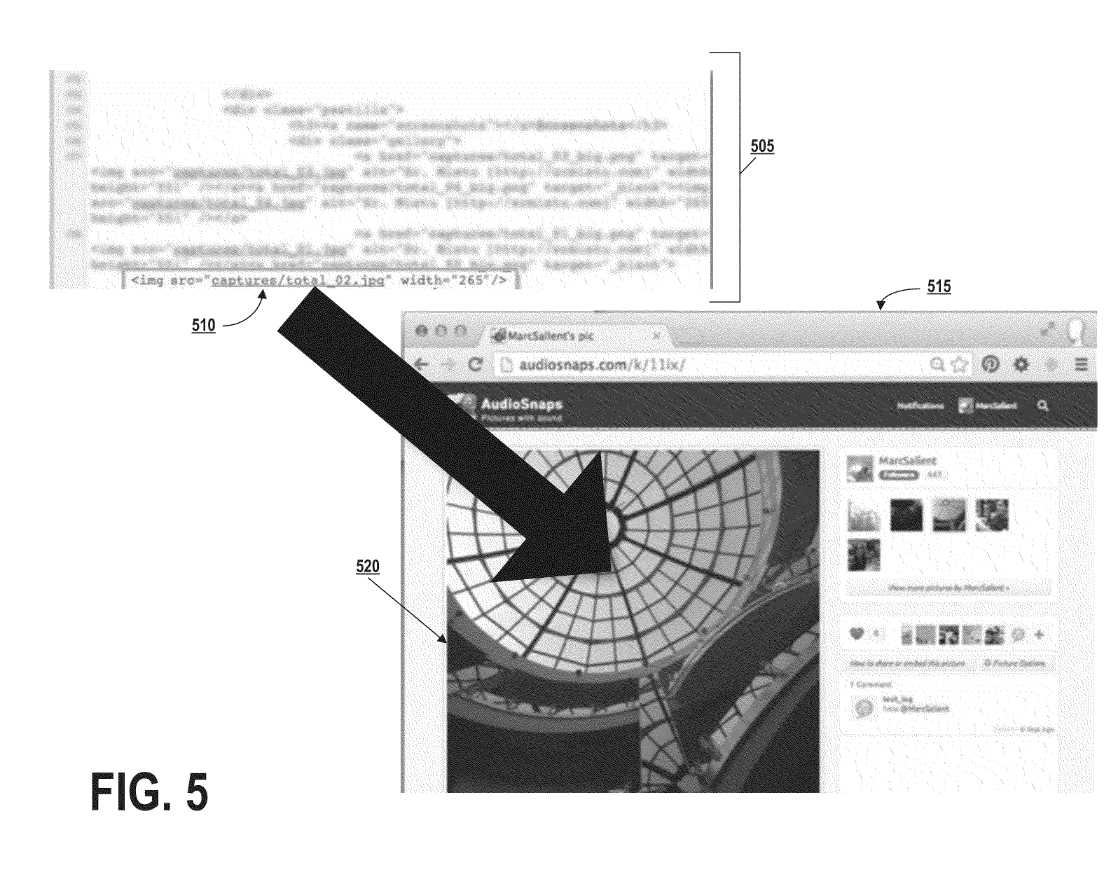

At 410, an image identifier can be identified. In certain implementations, such an image identifier can be identified within a content page, such as a webpage or any other such content presentation interface. For example, upon loading a webpage (such as at/in conjunction with a web browser executing on a user device) one or more image identifiers (corresponding to relative paths, references, addresses, and/or links to images, such as images that are incorporated within a webpage) can be identified, such as by parsing or otherwise processing the source code of such a web page. For example, FIG. 5 depicts source code 505 of a web page that can be received by a web browser 515 for presentation therein. As can be appreciated with reference to FIG. 5, source code 505 can include one or more image identifiers, such as image identifier 510 which is a relative path or reference to an image file (as may be stored, for example, on a webserver), such as image 520, that is incorporated within a web page.

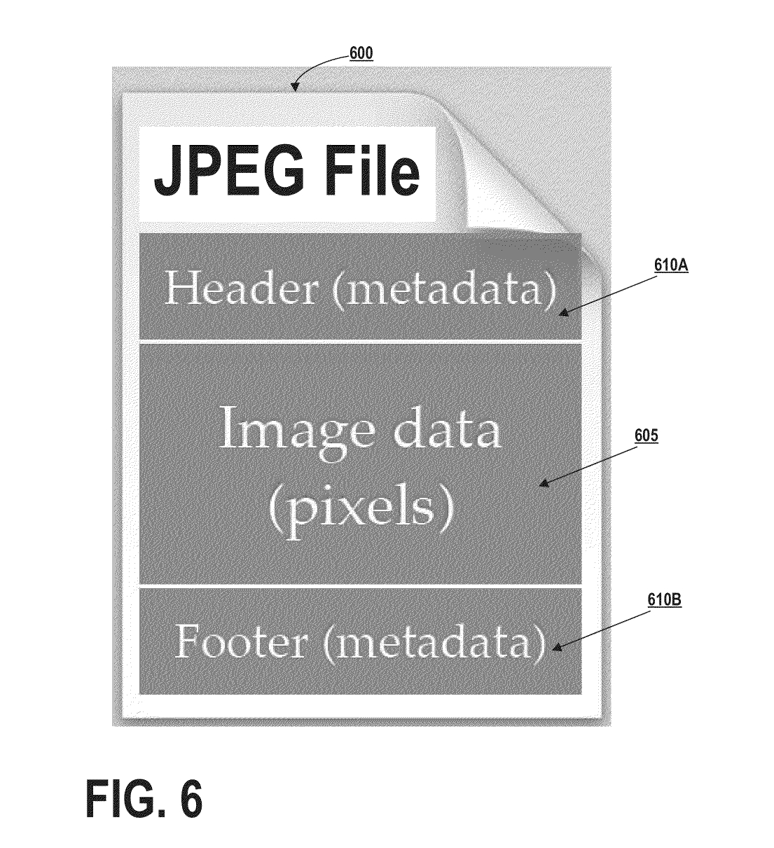

As noted, an image identifier (such as a path or reference to an image incorporated within a web page) can correspond to a digital image file. In certain implementations, such a digital image file (e.g., the digital image file as stored on a webserver) can include image data (e.g., pixel information that reflects the visual aspects of the image) as well as supplemental data (e.g., metadata, such as the header, footer, tags, etc., that are stored as part of the image file). For example, FIG. 6 depicts an exemplary structure of a digital image file 600. As can be appreciated with reference to FIG. 6, and as described herein, digital image file 600 includes image data 605, as well as supplemental data 610A (corresponding to a header of the file) and 610B (corresponding to a footer of the file). Moreover, it should be understood that, in various implementations, the referenced supplemental data can include media content (as can be embedded, for example, in the manner described herein, such as with reference to FIG. 3). As also described herein, examples of the referenced supplemental data include, but are not limited to media content such as audio data and/or media content codified as encoded data and embedded within a tag of the digital image file (such as in the manner described herein).

It should be understood that while a digital image file stored on a webserver (such as digital image file 600 as depicted in FIG. 6) includes both image data (e.g., pixels) and supplemental data (e.g., metadata, tags, etc.), in many scenarios upon processing (such as by a web browser) an image identifier corresponding to such an image (such as incorporated within a webpage as shown in FIG. 5), while the image data of the image file (e.g., image data 605 as shown in FIG. 6) can be requested, received, and/or otherwise incorporated within the webpage as depicted in a web browser (such as is shown in FIG. 5), the supplemental data (e.g., header 610A and/or footer 610B as depicted in FIG. 6) may not be requested or received, and/or may be otherwise ignored or discarded by the web browser. In certain implementations, the handling/processing of image files in this manner can be dictated by the Document Object Model (DOM) standard/convention, and/or any other such standard, as is known to those of ordinary skill in the art.

While in certain implementations a content page can be processed, such as in a manner described herein, to identify one or more image identifiers therein (e.g., substantially all of the image identifiers within a web page), in other implementations one or more indications and/or other such identifying characteristics or markings can be associated with or otherwise attributed to such image identifiers, and the identifying operation described herein can be configured to identify image identifiers having such characteristics/markings. In doing so, those image file(s) having media content embedded therein can be identified (while increasing processing efficiency by avoiding other image files that may not have such embedded media content). By way of example, one or more specified classes can be added to a tag of a digital image file (e.g., <img src=“image/path/im.jpeg” class=“any other koepics”>). By way of further example, a file naming convention or extension can be utilized to identify image identifiers that correspond to image files (e.g., <img src=“/image/path/whatever.audio.jpeg”>).

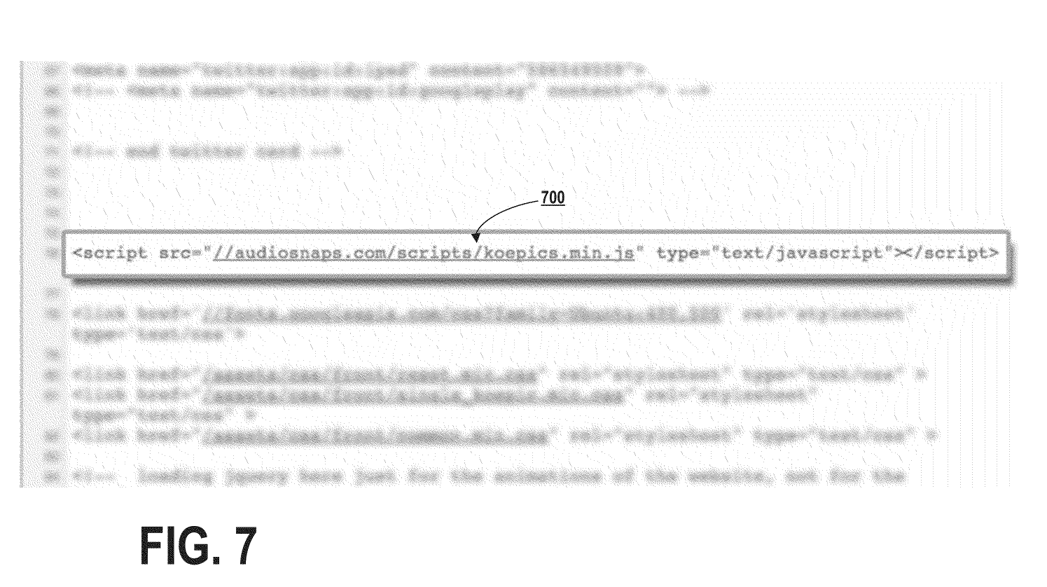

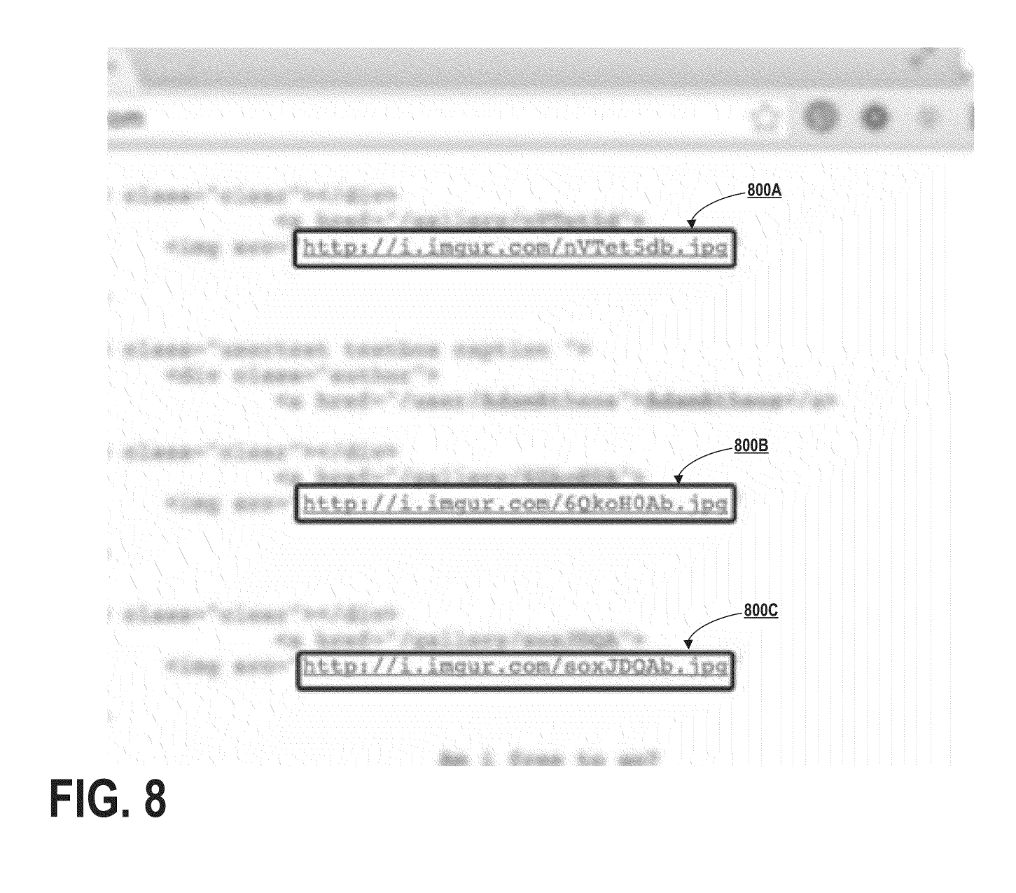

At 420, the image identifier (such as the image identifier identified at 420) can be processed. In doing so, a source address/source path of the digital image file can be identified or otherwise determined. In certain implementations, the referenced processing (and/or one or more of the other operations described herein) can be performed by and/or in conjunction with a file or script (e.g., in Javascript), though it should be understood that any number of other implementations are also contemplated (e.g., though the use of a browser plug-in providing comparable functionality, as are known to those of ordinary skill in the art). FIG. 7 depicts an example of such a script 700 which can be included within a webpage and can enable one or more of the described operations to be implemented, such as in a manner known to those of ordinary skill in the art. Moreover, FIG. 8 depicts examples of various source paths 800A, 800B, and 800C corresponding to various image files that can be identified such as in a manner known to those of ordinary skill in the art and/or as described herein.

In certain implementations, at 430 receipt of image data by a content viewer can be prevented. That is, having identified the source path/address of one or more image files, the request and/or receipt of image data (e.g., image data 605 as depicted in FIG. 6) can be prevented or otherwise precluded. In doing so, the request of such image data alone (as is achieved using techniques known to those of ordinary skill in the art), such as via DOM techniques in a web browser in relation to an image identifier can be prevented, such as in lieu of a request for source code information for such an image, such as is described herein.

At 440, source code information of the digital image file can be requested. In certain implementations, such source code information can be requested based on and/or in conjunction with a source path/address of the image file (such as the source path/address identified at 420). In certain implementations, the referenced source code information can include encoded data and/or binary data, such as data encoded in the manner described herein, such as in relation to FIG. 3. It should be understood that, as described herein, such encoded data can include media content, such as an audio file.

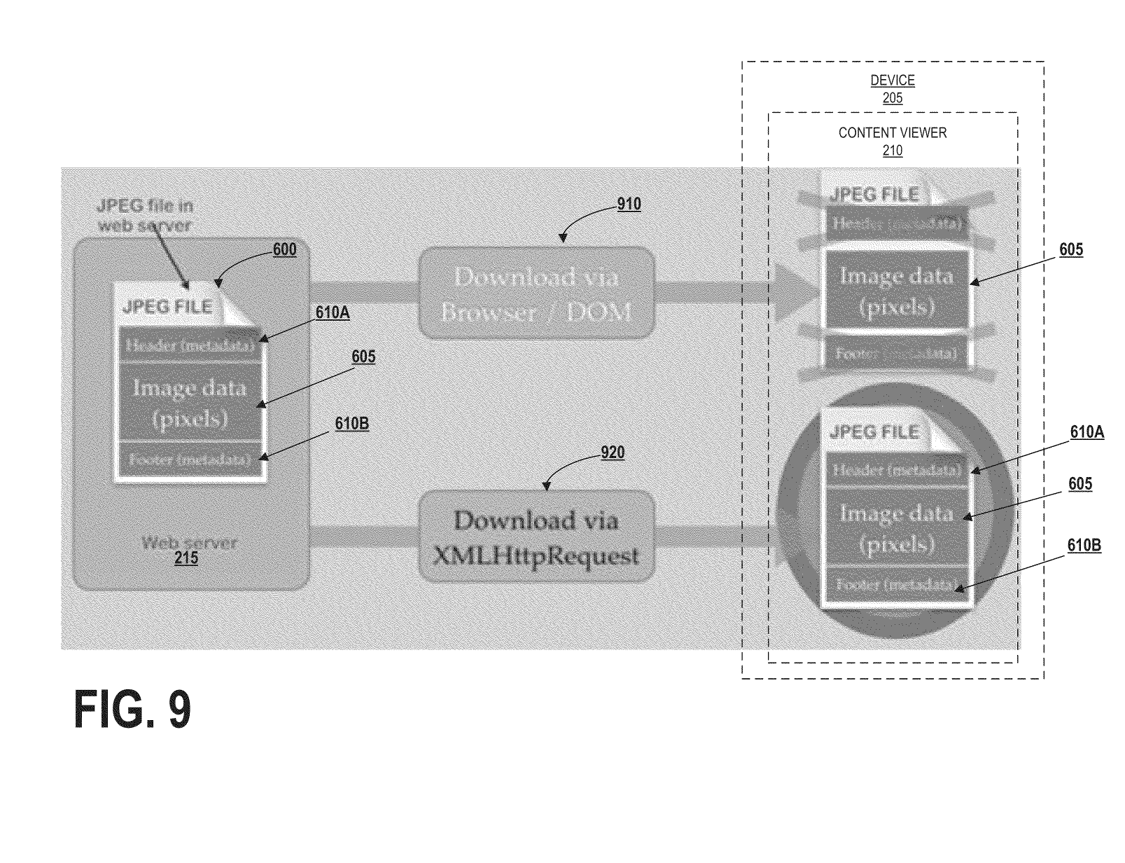

By way of illustration, FIG. 9 depicts an exemplary scenario whereby digital image file 600 can be requested by content viewer 210 (e.g., a web browser) of device 205 (e.g., a computer, mobile device, etc.) via an XMLHttpRequest 920, an XMLHTTP ActiveXObject, and/or any other such request through which the content viewer can obtain all of the data that makes up the image file (including image data and supplemental data such as metadata, tags, etc.), as is known to those of ordinary skill in the art. As can also be appreciated with reference to FIG. 9, in certain implementations a standard web browser/DOM request 910 can be performed with respect to the image data itself (as occurs, for example, with respect to ordinary web site image requests), while request 920 occurs substantially in parallel (e.g., with respect to the supplemental data not included in request 910, and/or with respect to the image data as well).

Moreover, at 450, the source code information (such as the source code information requested at 440) can be received. In certain implementations, such source code information can be received as a binary file, text file, and/or any other such combination of codifications and/or MIME types that, when implemented, can enable the various operations described herein to request and/or receive the source code of a digital image file.

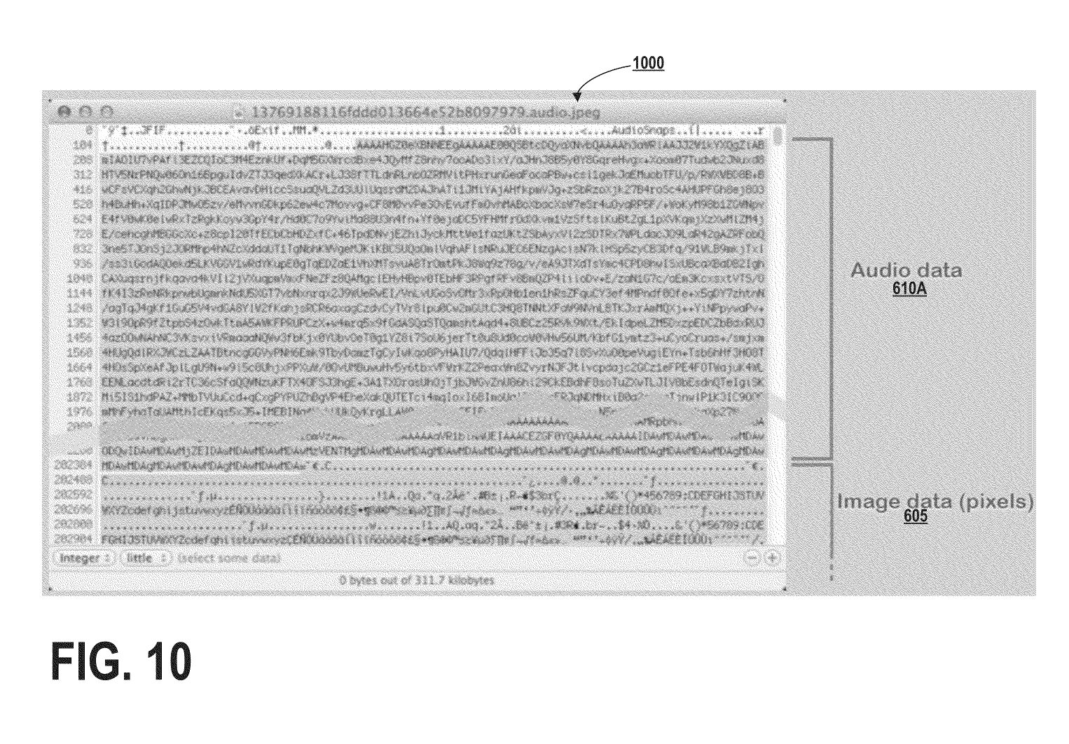

At 460, the source code information (such as the source code information requested at 440 and/or received at 450) can be processed. In doing so, the supplemental data (e.g., media content such as audio content embedded within metadata of the image file, such as within the header, footer, EXIF, etc. of the image file) can be identified. For example, FIG. 10 depicts the source code information 1000 of an image file. In processing the source code information, supplemental data (e.g., audio data 610A) can be identified, and distinguished, for example, from image data 605, as shown. As described herein, in certain implementations one or more markers can be inserted within the source code information in order to identify the beginning/end of the audio file, for example.

At 470, the supplemental data (e.g., the media content identified from the source code information) can be provided, such as in conjunction with the content page (e.g., a website). For example, such supplemental data (e.g., an audio file) can be provided within a webpage, together with a player or any other such handler configured to enable such content to be provided (e.g., played) in conjunction with the content page. Moreover, in certain implementations, the referenced supplemental data can be provided in conjunction with the content page (e.g., a webpage) in response to a user input. For example, audio content embedded within an image file can be played (e.g., loaded ‘on the fly’) upon receiving a selection of an icon or control provided within the webpage, and/or at any other such interval as can be defined by a developer, such as in a manner known to those of ordinary skill in the art (e.g., not necessarily when the script is executed).

By way of illustration, having identified or otherwise extracted supplemental data such as an audio file, such audio can be played via a web browser in any number of ways. For example, an audio tag can be added to the web page (e.g., <audio> <source src=‘data:audio/x-m4a; base64,BASE_{—}64_AUDIO_STRING’ /> </audio>, where BASE_{—}64_AUDIO_STRING is the extracted audio string that was embedded within the image file). By way of further example, an AudioContext interface (or any other such object) can be created, through which the audio file can be played, such as in a manner known to those of ordinary skill in the art.

It should be noted that while much of the foregoing description had been provided with respect to a single image file, the various techniques described herein can be similarly implemented with respect to multiple files, file formats, etc., (e.g., simultaneously, in parallel, etc.), such as in a manner known to those of ordinary skill in the art.

At this juncture, it should be noted that although much of the foregoing description has been directed to systems and methods for image enhancement and content presentation, the systems and methods disclosed herein can be similarly deployed and/or implemented in scenarios, situations, and settings far beyond the illustrated scenarios. It can be readily appreciated that image enhancement system 100 and/or the content presentation system 200 can be effectively employed in practically any scenario where various image enhancement/content presentation approaches, including functions which enable the embedding of one file or file type within another, the extraction of one file from another and the providing of both files in conjunction with one another, etc., can be useful. It should be further understood that any such implementation and/or deployment is within the scope of the systems and methods described herein.

It is to be understood that like numerals in the drawings represent like elements through the several figures, and that not all components and/or steps described and illustrated with reference to the figures are required for all embodiments or arrangements. It should also be understood that the embodiments, implementations, and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein. It should be appreciated that according to at least one embodiment, one or more computer programs, modules, and/or applications that when executed perform one or more of the various methods described herein need not reside on a single computer or processor, but can be distributed in a modular fashion amongst a number of different computers or processors to implement various aspects of the systems and methods disclosed herein.

Thus, illustrative embodiments and arrangements of the present systems and methods provide computer implemented methods, computer systems, and computer program products for embedding media content and providing media content. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present disclosure, which is set forth in the following claims.

What is claimed is:

1. A method comprising:
identifying, with a processing device, an image identifier within a content page, the image identifier corresponding to a digital image file, the digital image file comprising image data and supplemental data;
processing the image identifier to identify a source address of the digital image file;
requesting, based on the source address, source code information of the digital image file;
processing the source code information to identify the supplemental data; and
providing the supplemental data in conjunction with the content page.

2. The method of claim 1, further comprising receiving the source code information.

3. The method of claim 1, further comprising preventing receipt of the image data by a content viewer.

4. The method of claim 1, wherein the supplemental data comprises audio data.

5. The method of claim 1, wherein the supplemental data comprises media content codified as encoded data and embedded within a tag of the digital image file.

6. The method of claim 1, wherein the source code information comprises encoded data.

7. The method of claim 1, wherein the source code information comprises binary data.

8. The method of claim 1, wherein providing the supplemental data comprises providing, in conjunction with the content page, the supplemental data and a player to provide the supplemental data in conjunction with the content page.

9. The method of claim 1, wherein providing the supplemental data comprises providing the supplemental data in conjunction with the content page in response to a user input.

10. A system comprising:
a memory; and
a processing device, coupled to the memory, to:
identify an image identifier within a content page, the image identifier corresponding to a digital image file, the digital image file comprising image data and supplemental data;
process the image identifier to identify a source address of the digital image file;
request, based on the source address, source code information of the digital image file;
process the source code information to identify the supplemental data; and
provide the supplemental data in conjunction with the content page.

11. The system of claim 10, wherein the processing device is further to prevent receipt of the image data by a content viewer.

12. The system of claim 10, wherein the supplemental data comprises media content codified as encoded data and embedded within a tag of the digital image file.

13. The system of claim 10, wherein the source code information comprises encoded data.

14. The system of claim 10, wherein the source code information comprises binary data.

15. The system of claim 10, wherein to provide the supplemental data is to provide, in conjunction with the content page, the supplemental data and a player to provide the supplemental data in conjunction with the content page.

16. The system of claim 10, wherein to provide the supplemental data is to provide the supplemental data in conjunction with the content page in response to a user input.

17. A computer readable medium having instructions stored thereon that, when executed by a processor, cause the processor to perform operations comprising:
receiving media content;
codifying the media content as encoded data based on one or more encoding formats;
embedding the encoded data within an image file; and
providing a composite of the image file and the media content.

18. The computer readable medium of claim 17, wherein embedding the encoded data within the image file comprises adding the encoded data into an EXIF tag of the image file.

19. The computer readable medium of claim 17, wherein embedding the encoded data within the image file comprises incorporating the encoded data and a marking string into an EXIF tag of the image file.

20. The computer readable medium of claim 17, wherein embedding the encoded data within the image file comprises dividing the encoded data into one or more encoded data elements, and adding the encoded data elements into one or more EXIF tags of the image file.
